(19) United States
(12) Patent Application Publication
(10) Pub. No.: US 2022/0083881 A1
(43) Pub. Date: Mar. 17, 2022

(54) AUTOMATED ANALYSIS GENERATION FOR MACHINE LEARNING SYSTEM

(71) Applicant: International Business Machines Corporation, Armonk, NY (US)

(72) Inventors: Arunima Chaudhary, Boston, MA (US); Dakuo Wang, Cambridge, MA (US); David John Piorkowski, White Plains, NY (US); Daniel M. Gruen, Newton, MA (US); Chuang Gan, Cambridge, MA (US); Peter Daniel Kirchner, PUTNAM VALLEY, NY (US); Gregory Bramble, Larchmont, NY (US); Bei Chen, Blanchardstown (IE); Abel Valente, Villa Elisa (AR); Carolina Maria Spina, Olavarria (AR); John Thomas Richards, Honeoye Falls, NY (US); Abhishek Bhandwaldar, Somerville, MA (US)

(21) Appl. No.: 17/020,299

(22) Filed: Sep. 14, 2020

(51) Int. Cl. G06N 5/04; G06N 20/00; G06N 5/02

(52) U.S. Cl. CPC G06N 5/045; G06N 5/022; G06N 20/00

(57) ABSTRACT

An automated analytic tool (AAT) apparatus analyzes a machine learning system (MLS). The tool comprises a processor configured to receive experiment parameters associated with an experiment performed on the MLS, and captures information from a plurality of stages of the experiment. The information comprises information regarding MLS results and choices made during the experiment. The tool automatically revise the captured information into revised information utilizing a knowledge base comprising information from prior experiments. The tool then presents the revised information to a user.

### BACKGROUND

Disclosed herein is a system and related method for an analysis generation for a machine learning system, and more specifically an analysis generation that includes automated report generation with a memory network knowledge base for automated machine learning systems.

The system and method described herein relates to various fields, including, but not limited to, human-computer interaction, artificial intelligence, automatic machine learning, and data science. The initiative for automated machine learning predictive systems is to mimic the expertise and workflow of data scientists. The expertise of a human data scientist is most valuable in three aspects: a) knowledge about a particular data science problem domain and dataset, b) insights about the choice of models (a data scientist typically considers a handful of models selected by prior knowledge), and c) insight into presentation of the decisions and the machine learning results to non-technical strategy analysts and business managers. The combination of these three aspects lead to achieving high accuracy and explainability in a timely manner. One problem, however, is that most automated machine learning (ML) systems mimic only the technical expertise of data scientists and stop at insights generation, and do not cover presentation.

There is a need in the industry to utilize a tool for analyzing ML systems, determining insights into their operation and the underlying models that they use, and to present this information in a meaningful and useful way.

### SUMMARY

According to one aspect disclosed herein, a computer-implemented method using a processor is provided to use an automated analytic tool (AAT) for analyzing a machine learning system (MLS). The tool receives experiment parameters associated with an experiment performed on the MLS, and captures information from a plurality of stages of the experiment. The information comprises information regarding MLS results and choices made during the experiment, and automatically revises the captured information into revised information utilizing a knowledge base comprising information from prior experiments. The tool presents the revised information to a user. Advantageously, this provides a method for analyzing ML systems, determining insights into their operation and the underlying models that they use, and to present this information in a meaningful and useful way.

According to another aspect disclosed herein, the method may further comprise utilizing a plurality of stages of the experiment that include a data refinement stage, a feature transform stage, a model selection stage, a model tuning stage, and a pipeline selection stage. Advantageously, utilizing a plurality of stages allows for a more meaningful and comprehensive reporting.

According to another aspect disclosed herein, the method may further comprise providing an explanation of rationale behind the choices made at each of the plurality of stages of the experiment. Advantageously, the provides additional insight to the user that may assist in developing a better system.

According to another aspect disclosed herein, the method may further comprise receiving a request, based on a user interaction with a display element on a user interface, to view or download the revised information of the experiment and present different possibilities of the experiment. Advantageously, this provides greater flexibility for the user in the experiment design.

According to another aspect disclosed herein, the method may further comprise receiving, via a question and answer mechanism, a user question associated with the experiment; and presenting an answer that is responsive to the user question. Advantageously, this may allow the user to obtain very focused information that is associated with the model(s).

According to another aspect disclosed herein, the method may further comprise receiving edit information from the user on the revised information; integrating the edit information into the knowledge base; and using the edit information for a future experiment. Advantageously, this permits experimental development to evolve into more useful formats.

According to another aspect disclosed herein, the knowledge base is structured as a memory network. Advantageously, this permits the application of AI tools and techniques to evolve model testing.

According to another aspect disclosed herein, the memory network comprises data from a plurality of stages of past experiments. Advantageously, information from past experiments may be helpful in designing better future experiments.

According to another aspect disclosed herein, the presenting of the revised information to the user comprises: presenting, for display on a user device: a progress map that pictorially illustrates progress of the experiment; a pipeline leader board that displays pipeline rankings, name, and algorithm; and a report user interface element that, when activated, initiates a report download and/or automatic generation of a viewable report. Advantageously, this organization provides a concise but intuitive view of the experiment for the user that enhances the user's ability to comprehend many details of the experiment in one view.

According to another aspect disclosed herein, an automated analytic tool (AAT) apparatus analyzes a machine learning system (MLS). The tool comprises a processor configured to receive experiment parameters associated with an experiment performed on the MLS, and captures information from a plurality of stages of the experiment. The information comprises information regarding MLS results and choices made during the experiment. The tool automatically revise the captured information into revised information utilizing a knowledge base comprising information from prior experiments. The tool then presents the revised information to a user. Advantageously, this provides a method for analyzing ML systems, determining insights into their operation and the underlying models that they use, and to present this information in a meaningful and useful way.

According to another aspect, the plurality of stages of the experiment include a data refinement stage, a feature transform stage, a model selection stage, a model tuning stage, and a pipeline selection stage. Advantageously, collecting, analyzing, and presenting data from a plurality of stages helps designers better assess operation of the ML system.

According to another aspect, the tool provides an explanation of rationale behind the choices made at each of the plurality of stages of the experiment. Knowledge of the rationale may help detect problems and potential solutions that would otherwise be difficult to determine.

According to another aspect, the tool receives a request, based on a user interaction with a display element on a user interface, to view or download the revised information of the experiment and present different possibilities of the experiment. Advantageously, knowing different possibilities of an experiment allows flexibility in assessing experimental design changes.

According to another aspect, the tool receives edit information from the user on the revised information, integrates the edit information into the knowledge base, and uses the edit information for a future experiment. Advantageously, this allows continuous improvement in that valuable information is expanded and less useful information is eliminated over time.

According to another aspect, the presenting of the revised information to the user comprises presenting, for display on a user device: a progress map that pictorially illustrates progress of the experiment; a pipeline leader board that displays pipeline rankings, name, and algorithm; and a report user interface element that, when activated, initiates a report download and/or automatic generation of a viewable report. Advantageously, presenting this information in a concise manner allows a viewer to rapidly visualize key features of the system design.

According to another aspect disclosed herein, a computer program product is provided that may be used for the methods or apparatuses described herein. The computer program product contains instructions that are accessible from a computer-usable or computer-readable medium providing program code for use by, or in connection with, a computer or any instruction execution system. For the purpose of this description, a computer-usable or computer-readable medium may be any apparatus that may contain a mechanism for storing, communicating, propagating, or transporting the program for use by, or in connection with, the instruction execution system, apparatus, or device.

### BRIEF DESCRIPTION OF THE DRAWINGS

Various embodiments are described herein with reference to different subject matter. In particular, some embodiments may be described with reference to methods, whereas other embodiments may be described with reference to apparatuses and systems. However, a person skilled in the art will gather from the above and the following description that, unless otherwise indicated, in addition to any combination of features belonging to one type of subject matter, also any combination of features relating to different subject matter, in particular, features of the methods and features of the apparatuses and systems, are considered to be disclosed within this document.

The aspects defined above, and further aspects disclosed herein, are apparent from the examples of one or more embodiments described hereinafter and are explained with reference to the examples of the one or more embodiments. However, the invention is not limited to these examples. Various embodiments are described, by way of example only, with reference to the following drawings:

FIG. 1A is a block diagram of a data processing system (DPS) according to one or more embodiments disclosed herein.

FIG. 1B is a pictorial diagram that depicts a cloud computing environment according to an embodiment disclosed herein.

FIG. 1C is a pictorial diagram that depicts abstraction model layers according to an embodiment disclosed herein.

FIG. 2 is a flow diagram of a process that may be utilized in an AI lifecycle management cycle for building and deploying an AI platform, according to some embodiments.

FIG. 3 is a block flow diagram of a process and respective entities that may be utilized in some embodiments.

FIG. 4 is an algorithm workflow diagram of a process that may be utilized herein, according to some embodiments.

FIG. 5 is an example of a display screen on a user interface device, such as a monitor, according to some embodiments.

FIG. 6 a flowchart of an example process that may be used herein, according to some embodiments.

### DETAILED DESCRIPTION

The following acronyms may be used below:

AAI automated artificial intelligence
AAT automated analytic tool
AI artificial intelligence
AML automated machine learning
API application program interface
ARM advanced RISC machine
ART adaptive resonance theory
BERT bidirectional encoder representations from transformers
CD-ROM compact disc ROM
CMS content management system
CNN convolutional neural network
CoD capacity on demand
CPU central processing unit
CUoD capacity upgrade on demand
DPS data processing system
DVD digital versatile disk
EPROM erasable programmable read-only memory
FPGA field-programmable gate arrays
GUI graphical user interface
HA high availability
HPO hyperparameter optimization
IaaS infrastructure as a service
I/O input/output
IPL initial program load
ISP Internet service provider
ISA instruction-set-architecture
LAN local-area network
LPAR logical partition
LSTM long short-term memory
ML machine learning
MLP multi-layer perceptron
MLS machine learning system
MSE mean squared error
PaaS platform as a service
PDA personal digital assistant
PLA programmable logic arrays
RAM random access memory
RISC reduced instruction set computer
ROM read-only memory
SaaS software as a service
SLA service level agreement
SOM self-organizing map
SRAM static random-access memory
SVM support vector machine
WAN wide-area network

### Data-Related Computer Systems in General

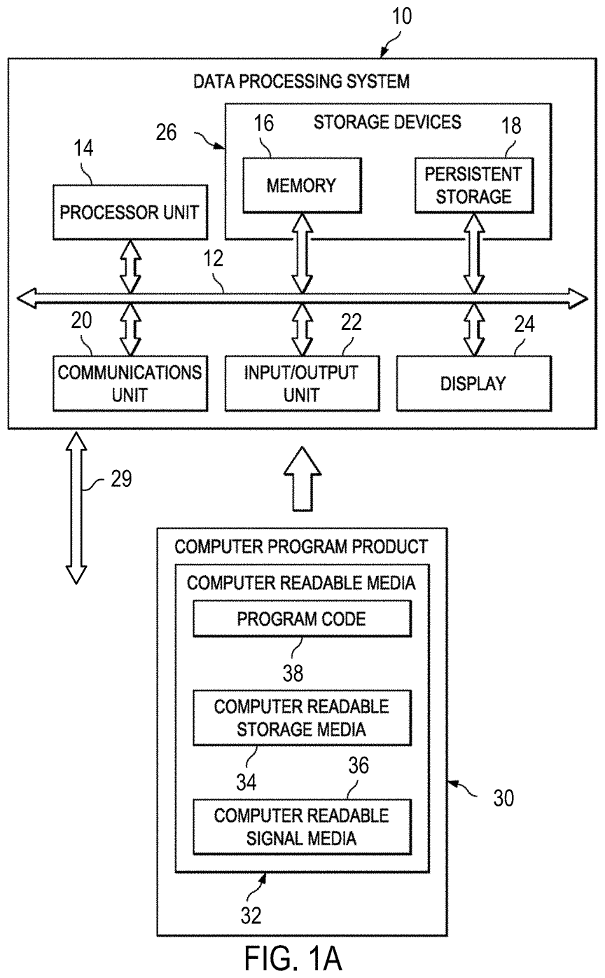

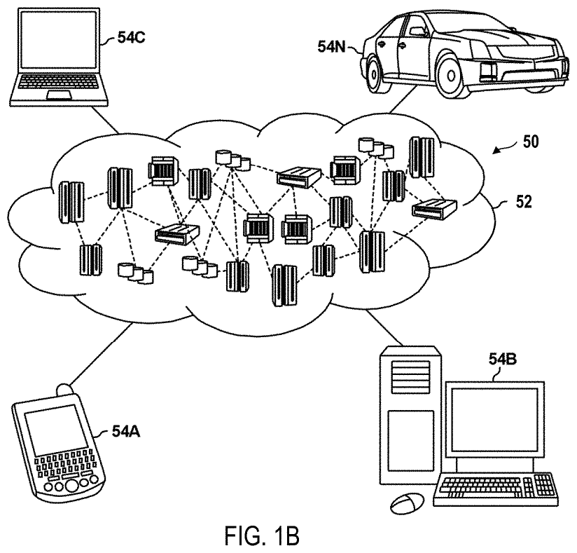

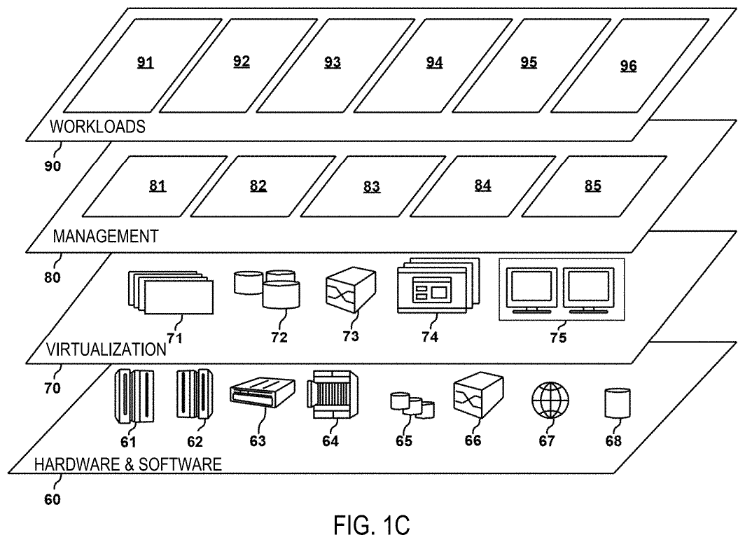

FIG. 1A is a block diagram of an example DPS according to one or more embodiments. In this illustrative example, the DPS 10 may include communications bus 12, which may provide communications between a processor unit 14, a memory 16, persistent storage 18, a communications unit 20, an I/O unit 22, and a display 24.

The processor unit 14 serves to execute instructions for software that may be loaded into the memory 16. The processor unit 14 may be a number of processors, a multi-core processor, or some other type of processor, depending on the particular implementation. A number, as used herein with reference to an item, means one or more items. Further, the processor unit 14 may be implemented using a number of heterogeneous processor systems in which a main processor is present with secondary processors on a single chip. As another illustrative example, the processor unit 14 may be a symmetric multi-processor system containing multiple processors of the same type.

The memory 16 and persistent storage 18 are examples of storage devices 26. A storage device may be any piece of hardware that is capable of storing information, such as, for example without limitation, data, program code in functional form, and/or other suitable information either on a temporary basis and/or a permanent basis. The memory 16, in these examples, may be, for example, a random access memory or any other suitable volatile or non-volatile storage device. The persistent storage 18 may take various forms depending on the particular implementation.

For example, the persistent storage 18 may contain one or more components or devices. For example, the persistent storage 18 may be a hard drive, a flash memory, a rewritable optical disk, a rewritable magnetic tape, or some combination of the above. The media used by the persistent storage 18 also may be removable. For example, a removable hard drive may be used for the persistent storage 18.

The communications unit 20 in these examples may provide for communications with other DPSs or devices. In these examples, the communications unit 20 is a network interface card. The communications unit 20 may provide communications through the use of either or both physical and wireless communications links.

The input/output unit 22 may allow for input and output of data with other devices that may be connected to the DPS 10. For example, the input/output unit 22 may provide a connection for user input through a keyboard, a mouse, and/or some other suitable input device. Further, the input/output unit 22 may send output to a printer. The display 24 may provide a mechanism to display information to a user.

Instructions for the operating system, applications and/or programs may be located in the storage devices 26, which are in communication with the processor unit 14 through the communications bus 12. In these illustrative examples, the instructions are in a functional form on the persistent storage 18. These instructions may be loaded into the memory 16 for execution by the processor unit 14. The processes of the different embodiments may be performed by the processor unit 14 using computer implemented instructions, which may be located in a memory, such as the memory 16. These instructions are referred to as program code 38 (described below) computer usable program code, or computer readable program code that may be read and executed by a processor in the processor unit 14. The program code in the different embodiments may be embodied on different physical or tangible computer readable media, such as the memory 16 or the persistent storage 18.

The DPS 10 may further comprise an interface for a network 29. The interface may include hardware, drivers, software, and the like to allow communications over wired and wireless networks 29 and may implement any number of communication protocols, including those, for example, at various levels of the Open Systems Interconnection (OSI) seven layer model.

FIG. 1A further illustrates a computer program product 30 that may contain the program code 38. The program code 38 may be located in a functional form on the computer readable media 32 that is selectively removable and may be loaded onto or transferred to the DPS 10 for execution by the processor unit 14. The program code 38 and computer readable media 32 may form a computer program product 30 in these examples. In one example, the computer readable media 32 may be computer readable storage media 34 or computer readable signal media 36. Computer readable storage media 34 may include, for example, an optical or magnetic disk that is inserted or placed into a drive or other device that is part of the persistent storage 18 for transfer onto a storage device, such as a hard drive, that is part of the persistent storage 18. The computer readable storage media 34 also may take the form of a persistent storage, such as a hard drive, a thumb drive, or a flash memory, that is connected to the DPS 10. In some instances, the computer readable storage media 34 may not be removable from the DPS 10.

Alternatively, the program code 38 may be transferred to the DPS 10 using the computer readable signal media 36. The computer readable signal media 36 may be, for example, a propagated data signal containing the program code 38. For example, the computer readable signal media 36 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 38 may be downloaded over a network to the persistent storage 18 from another device or DPS through the computer readable signal media 36 for use within the DPS 10. For instance, program code stored in a computer readable storage medium in a server DPS may be downloaded over a network from the server to the DPS 10. The DPS providing the program code 38 may be a server computer, a client computer, or some other device capable of storing and transmitting the program code 38.

The different components illustrated for the DPS 10 are not meant to provide architectural limitations to the manner in which different embodiments may be implemented. The different illustrative embodiments may be implemented in a DPS including components in addition to or in place of those illustrated for the DPS 10.

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1B, illustrative cloud computing environment 52 is depicted. As shown, cloud computing environment 52 includes one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 52 to offer infrastructure, platforms and/or software as services for which a cloud consumer does not need to maintain resources on a local computing device. It is understood that the types of computing devices 54A-N shown in FIG. 1B are intended to be illustrative only and that computing nodes 50 and cloud computing environment 52 can communicate with any type of computerized device over any type of network and/or network addressable connection (e.g., using a web browser).

Referring now to FIG. 1C, a set of functional abstraction layers provided by cloud computing environment 52 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

Any of the nodes 50 in the computing environment 52 as well as the computing devices 54A-N may be a DPS 10.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

### Automated Analysis Generation

System Overview

Automated machine learning predictive systems mimic the expertise and workflow of data scientists, but one problem is that most automated machine learning (ML) systems mimic only the technical expertise of data scientists and stop at insights generation, and do not cover presentation. Disclosed herein is a tool for analyzing ML systems, determining insights into their operation and the underlying models that they use, and to present this information in a meaningful and useful way to users who may be system designers.

An automated system and method are described herein that improve on data scientist expertise, particularly their insights and presentation of insights. The system, an automated analytic tool (AAT) automatically generates an analysis (e.g., documentation) to present a machine learning system (MLS) model results, choices made in the process, and rationale as to why the model made such choices. Automated artificial intelligence (AAI) applications, such as AutoAI® and automated machine learning (AML) applications, such as AutoML® use programs and algorithms to automate end to end human intensive and otherwise highly skilled tasks involved in building and operationalizing artificial intelligence (AI) models. Advantageously, in an AI lifecycle management cycle, such automation programs may be used to automate: data preparation, model development, feature engineering, and hyperparameter optimization, among other things.

Disclosed herein is a system, apparatus, and method to provide users with feedback and analytics, in some implementations in the form of an automatically generated report, that presents insights regarding model results, choices made in the process, and rationales behind those choices in the field of AAI and AML.

The AAT may be able to receive and process optional feedback from users on the report, including, but not limited, to capturing any editing done, such as that for a final version. This optional feedback may be used to tune and train the report AAT, including an attentional mechanism, so the AAT learns what to include and what to leave out in the analysis and reports it generates. This training can include learning specific needs for reports created for different domains, user roles, dataset and problem types, etc.

In some embodiments, a question/answer mechanism is provided through which users may ask questions about the analysis process or results whose answers could be included in the report. Some examples of user questions that may be processed by the system include “what were the biggest outliers?”, “which model performed the worst?”, “how did Model X perform?”, “why was Model X eliminated?”, “how does the Model Y perform for people of Characteristic E?”, etc.

By way of some embodiments of this system, automated documentation may be provided advantageously detailing the experiment results that makes it easier to read and transfer knowledge among users from multiple disciplines across businesses. In some embodiments, additional details regarding the choices made while deciding various data transforms, model selection, parameter tuning, etc., may also be provided. In some embodiments, a link is provided to view/download the report on the UI that helps the user to revisit the report for multiple experiments. Advantageously, the report generation improves over time, and the system learns to customize report characteristics for different situations.

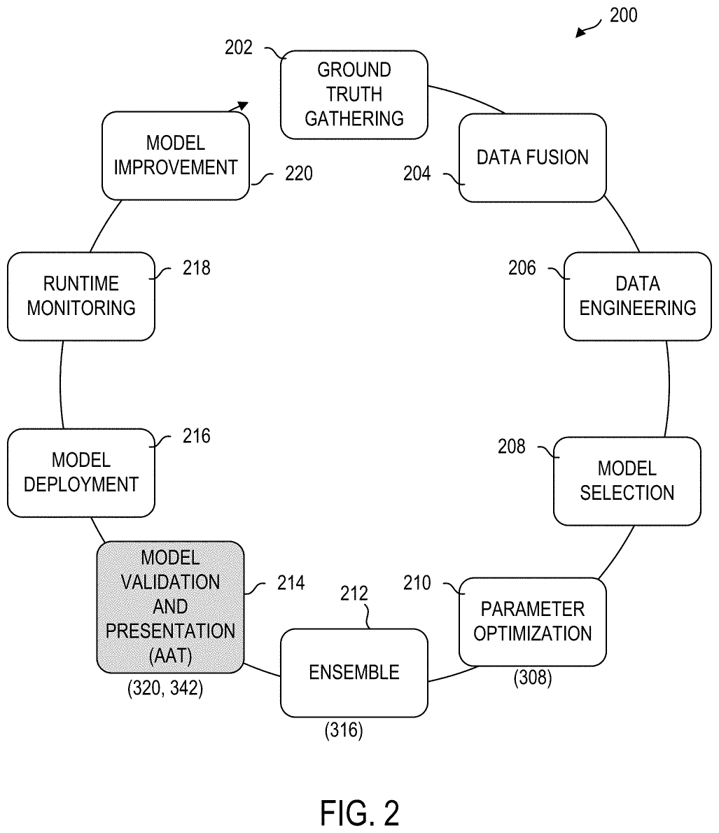

FIG. 2 is a flow diagram of a process 200 that may be utilized in an AI lifecycle management cycle for building and deploying an AI platform such as the MLS. The process 200 may comprise a ground truth gathering operation 202 where an initial dataset to be used to generate the machine learning models is gathered, evaluated, and approved. This may involve identifying the problem to be solved and understanding requirements to improve operations. In embodiments where ground truths are not generated by the user, ground truth may be determined using statistical techniques such as k-means clustering, mixture models, hierarchical clustering, hidden Markov models, blind signal separation, self-organizing maps (SOMs), adaptive resonance theory (ART), and any other applicable methods. Such ground truth gathering may define a standard, or measuring stick, of the data contained in user data.

The process 200 may then comprise a data fusion operation 204 in which multiple data sources are integrated to produce more consistent, accurate, and useful information than that provided by any individual data source. The data fusion operation 204, in some embodiments, uses the initial dataset and reaches out to a data repository for finding and joining additional data automatically, with some user interaction for the final selection of the data to be fused with the initial dataset.

It may then comprise a data engineering operation 206 in which mechanisms are developed for collecting and validating potentially large amounts of information. This operation 206 may be used to collect all raw data related to business requirements and prepare the data for use in applying machine learning. This step involves data cleansing and/or data engineering for use in training of machine learning models (or algorithms). Typically, data cleaning is performed to identify and remove errors in data, in order to create a clean (reliable) dataset for machine learning. This step is important because good data preparation and engineering produces clean and reliable data, which leads to more accurate model predictions. For example, if data is missing, the machine learning algorithm cannot use it. If data is invalid, the machine learning algorithm produces less accurate or even misleading outcomes. Cleansing of data may include removing outliers or biases included in the data based on the comparison of such data points to the ground truth. Following cleansing, additional data engineering may be performed in order to organize or classify the data into meaningful subsets that may be used in model training.

A model selection operation 208 may be used to select a particular statistical, AI, or other model from a set of candidate models, given data. In the simplest cases, a pre-existing set of data is considered. However, the task may also involve the design of experiments such that the data collected is well-suited to the problem of model selection. Selecting a model from a collection of candidate machine learning models for training may be performed with the prepared and cleaned dataset. Examples of suitable machine learning models include linear or logistical regression algorithms, instance-based algorithms, regularization algorithms, decision tree algorithms, clustering algorithms, association rule learning algorithms, artificial neural network algorithms, deep learning algorithms, dimensionality reduction algorithms, ensemble algorithms, linear regression, logistical regression, random forest, gradient boosted trees, support vector machines (SVM), neural networks (including convolutional neural networks and deep learning networks), decision trees, naive Bayes, nearest neighbor, etc.

In a (hyper)parameter optimization operation 210, a set of optimal hyperparameters may be chosen for the learning algorithm, where the hyperparameters are parameters whose values are used to control the learning process, in contrast to the values of other parameters (typically node weights), which are learned. The selected model may be improved by tuning or optimizing the hyperparameters. During this step, a set of optimal hyperparameters may be selected and the selected hyperparameters determine the structure of the machine learning model.

In the ensemble operation 212, ensemble methods use multiple learning algorithms to obtain better predictive performance than could be obtained from any of the constituent learning algorithms alone. If two or more models are selected, then the models are combined to produce one optimal predictive model. Once the selected model is trained and tuned, during the model validation step, the model is evaluated with the testing dataset. The model is validated until it produces a desired behavior. Unlike a statistical ensemble in statistical mechanics, which is usually infinite, a machine learning ensemble consists of only a concrete finite set of alternative models, but typically allows for much more flexible structures to exist among those alternatives.

The process 200 continues with a model validation and presentation operation 214, which is a focus of the present disclosure and is discussed in more detail below. It may be implemented by the AAT. The selected and trained elements may be displayed to the user through a user interface. The user interface may provide a mechanism to score each of the AI pipelines and display a ranking of the pipelines in order along with their score. Additionally, the user interface may display each AI pipeline element, and have an interface showing connections between each element (when applicable).

The process 200 further continues with a model deployment operation 216, in which the machine learning model is released to the production environment during a model deployment step to start making predictions by processing unseen (or new) data. A further step in the machine learning lifecycle is to monitor (e.g., runtime monitoring) 218 the deployed model and continue to improve its performance. The process 200 further continues with a model improvement operation 220 to continue to improve the model's performance.

When these processes are manually performed, they may be time-consuming, resource-intensive, labor-intensive, costly, and difficult to perform. To resolve these limitations, application of machine learning, automated machine learning, or automated artificial intelligence (AutoML or AutoAI), which is the process of automating the steps typically involved in applying machine learning to real-world business problems, has been considered within the technical field of machine learning.

An automated MLS, as described herein, may be used to assist a user with automating the machine learning processes and automate the complete pipeline from collecting a raw dataset to deploying machine learning models. However, the automated MLSs currently available in the marketplace have some limitations.

Embodiments of the disclosure described herein may be used to extend automated AutoML and AutoAI systems to automate a process of formulating a data science problem which enables the AutoAI/AutoML systems to generate more relevant models. For example, current AutoAI/AutoML systems typically use programs and algorithms to automate at least part of the end-to-end human intensive and otherwise highly skilled tasks involved in building and operationalizing AI models. The automated tasks can include, for example, one or more of data cleansing, data engineering, model selection, parameter optimization, ensemble operations, model validation, model deployment, runtime monitoring, and model improvement.

However, current AutoAI/AutoML systems operate on an assumption that the user or data scientist has a known dataset and a well-defined data science problem. In other words, the current AutoAI/AutoML systems assume that the user has sufficient domain and data science knowledge to formulate a computable data science problem. In practice, however, human users often do not have the necessary domain knowledge and, thus, may incorrectly formulate the data science problem to be solved. For example, the user may use meaningless features or select inappropriate feature transformers or algorithms, etc. The embodiments described herein enable the automated formulation of the data science problem based on the input dataset. In particular, the embodiments described herein enable this automation through machine learning techniques which help the system learn and improve in its formulation of data science problems and the results they produce. Thus, the embodiments described herein can improve the performance and output of AutoAI/AutoML systems through improved automated formulation of data science problems based on the data in the dataset itself and a knowledge base of previously collected information from prior experiments. Furthermore, although there can be differences between AutoAI and AutoML systems, as used herein, the term AutoAI is used to include both AutoAI and AutoML.

A computing device may include a processing unit executing instructions stored in a memory that may provide the improved functionality. This computing device may be a controller. This controller may be provided by a standalone computing device or integrated into a user device, integrated into a programming platform, or the like. By configuring the controller to automatically formulate the data science problem, the performance of an AutoAJIAutoML system, such as an AutoAI system, is improved by, for example, formulating the data science problem includes determining configuration settings for the AutoAJIAutoML system. Thus, by improving the formulation of the data science problem, the corresponding configuration settings applied to the AutoAJIAutoML systems are also improved which result in improved performance of the AutoAI/AutoML systems.

A controller may be used to automatically formulate a data science problem based on data in an input dataset. which may be implemented using a DPS 10 (FIG. 1A). Similarly, each user device, AutoAI system, and data repository may include one or more computing devices. The AutoAI system may include a computing device that generates models based on the data science problem and configurations formulated by the controller. For purposes of explanation, the discussion of an environment or system refers to an AutoAI system.

A data repository can include one or more databases that store information regarding prior input data sets as well as corresponding manual configurations selected by a user for the prior input datasets. That is, the prior datasets stored in the data repository have been processed previously by the AutoAI/AutoML system using configuration settings manually selected by a user and/or generated by the controller. The controller may use the data in the data repository to automatically formulate a data science problem and configuration settings for new input data. Though each of controller, user device, AutoAI system, and data repository are depicted as discrete entities (e.g., such that each may comprise or be hosted on separate computing devices), in some examples some of these entities may be on a shared computing device. For example, controller may be hosted on user device and/or a computing device that stores both AutoAI system and data repository. Additionally, one or more of the controller, user device, AutoAI system, and data repository can each be comprised of more than one device. For example, data repository can be comprised of a plurality of data servers or storage devices with data distributed across the plurality of storage devices.

These various computing devices of an environment can communicate over a network. The network can include a computing network over which computing messages may be sent and/or received. For example, network can include the Internet, a local area network (LAN), a wide area network (WAN), a wireless network such as a wireless LAN (WLAN), or the like. The network may comprise copper transmission cables, optical transmission fibers, wireless transmission, routers, firewalls, switches, gateway computers and/or edge servers. A network adapter card or network interface in each computing/processing device (e.g., controller, user device, AutoAI system, and/or data repository) may receive messages and/or instructions from and/or through network and forward the messages and/or instructions for storage or execution or the like to a respective memory or processor of the respective computing/processing device.

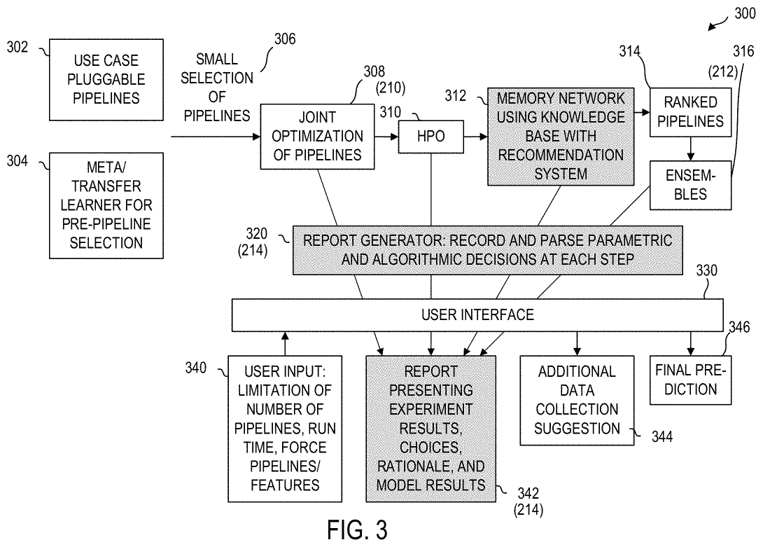

FIG. 3 is a block flow diagram of a process 300 and respective entities that may be utilized in some embodiments. AutoAI systems may generate multiple (e.g., hundreds) of machine learning pipelines. The AutoAI tool may output various ML models and their ranking in leaderboards, such as, for example, in a drop-down lists that show only their estimators plus parameters. However, such limited detail and depth of information fails to actually show how each machine learning model structure or how such machine learning model pipelines were created. When there is a large number of such machine learning model pipelines, a user is unable to adequately assess the composition, makeup, and overall architectural design/development and performance of these structures (e.g., the user is unable to keep track of their structure and performance in a concise manner). A machine learning model pipeline, an ensemble of a plurality of machine learning model pipelines, or a combination thereof, along with corresponding metadata (“pipeline”), may be generated using the one or more machine learning composition modules. Metadata may be extracted from the pipeline. The pipeline may be ranked according to metadata ranking criteria and pipeline ranking criteria. An interactive visualization graphical user interface (“GUI”) of the pipeline may be generated according to the rankings.

In operation 302, a particular use case or application of the system may implement pluggable pipelines. The pluggable pipelines are, for example, pluggable machine learning pipelines. Pluggable means that pipeline forms or templates are prepared that may be “plugged in” to the application with a few parameters so that the correct format is provided and so that they may be easily implemented by the users. Use cases may include pluggable pipelines such as, in a business context, financial credit card fraud detection. In operation 304, a meta/transfer learner is provided for pre-pipeline selection. This may be utilized to narrow down the scope of candidate pipelines to be considered in later processes.

A small selection of the pipelines 306 that have been pre-selected from the meta-learner module may then be provided to a procedure 308 for joint optimization of the pipelines (see operation 210 above), and the output may be provided to a hyperparameter optimization (HPO) routine 310 that choses a set of optimal hyperparameters for the learning algorithm. This optimization may utilize various approaches, including, but not limited to: a grid search, a random search, Bayesian optimization, gradient-based optimization, evolutionary optimization, population-based training, early stopping-based training, etc.

The memory network 312 is a knowledge base that combines learning strategies with a memory component that can be read and written to. The model is trained to learn how to operate effectively with the memory component. A high-level view of a memory network is as follows: there is a memory, m; an indexed array of objects (e.g. vectors or arrays of strings); an input feature map I, which converts the incoming input to the internal feature representation; and a generalization component G, which updates old memories given the new input. This is called generalization, since there is an opportunity for the network to compress and generalize its memories at this stage for some intended future use. An output feature map 0 produces a new output in the feature representation space given the new input and the current memory state. A response component R converts the output into the response format desired—for example, a textual response or an action. I, G, 0, and R may all potentially be learned components and make use of any ideas from the existing ML techniques.

Each fact in the knowledge base of the system may be represented as a latent feature vector. The AAT incorporates a memory network 312 that comprises a memory back that encodes the feature (or fact) vectors, and an attention module that learns to select a relevant fact for recommendation to the user or automated system. The memory network learns to leverage the facts in the knowledge base to automatically generate an analysis, such as a report. This may be achieved by utilizing pre-stored patterns of the pipeline structures in the knowledge base. For each type of structure, there is also a description stored in the knowledge base. In this way it is possible to map or to translate a given input pipeline structure into a text summary.

In operation 314, the user interface may provide a mechanism to score each of the AI pipelines and display a ranking of the pipelines in order along with their score. In operation 316, ensemble methods are used, as described above, employing multiple learning algorithms to obtain better predictive performance than could be obtained from any of the constituent learning algorithms alone. If two or more models are selected, then the models are combined to produce one optimal predictive model. Once the selected model is trained and tuned, during a model validation operation, the model is evaluated with the testing dataset. The model may be validated until it produces a desired behavior. Unlike a statistical ensemble in statistical mechanics, which is usually infinite, an ML ensemble consists of only a concrete finite set of alternative models, but typically allows for much more flexible structure to exist among those alternatives.

The report generator (AAT) 320 records and parses parametric and algorithmic decisions at each step of operations described below to provide users with detailed information. The report generator 320 collects information from the joint optimization of pipelines operation 308, the HPO 310, the memory network 312, and the ensemble operation 316. It then formats and passes this information through the user interface 330 to produce a displayable or printable analysis, such as a report 342 that presents experiment results, choices, rationale, and model results. User input 340 may be fed back to the system. The user input 340 may include, e.g., a limitation on the number of pipelines, run time, forcing or constraining of certain pipelines/features, etc. The user interface 330 may also allow for additional data collection suggestions in operation 344 by receiving user edit information that may relate to the revised information. By way of example, a suggestion may be “Could you please provide the hottest dates for this year?” This edit information may be provided to the knowledge base. It may also provide for a question and answer mechanism that allows the user to pose questions and receive answers. The answers may be obtained by querying the knowledge base using, e.g., a known query language. After a machine learning model is generated by AutoAI, the usage of the model pipeline provides it the system with a new data point, a final prediction is made of the new input data in operation 346.

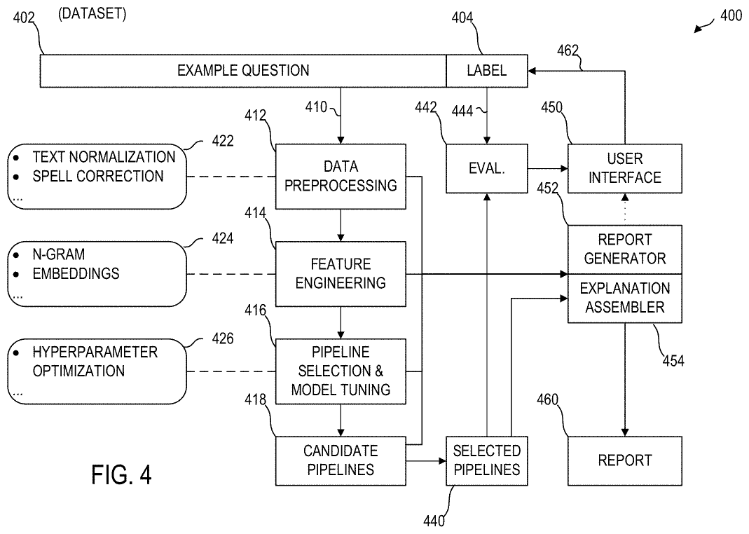

FIG. 4 is an algorithm workflow diagram of a process 400 that may be utilized herein. By way of illustrative example, example questions/comments 402 and associated labels 404 may be provided as input training datasets. In one use case, a first example question/comment 402 is, “A heroic tale of persistence that is sure to win viewers' hearts”, with an associated label 404 of “Positive”; a second example question/comment 402 is, “So-so entertainment”, with an associated label 404 of “Neutral”; and a third example question/comment 402 is, “You could hate it for the same reason”, with an associated label 404 of “Negative”.

This training data along with user preferences 410 may be passed along to various experiment stages that may include, by way of example, the following: In a data preprocessing stage 412, preliminary processing 422, such as text normalization, spelling correction, etc. may be performed. Once this preprocessing 412 is complete, feature engineering processing 424, such as n-gram and embeddings, may be implemented in a feature engineering stage 414. In a pipeline selection and model tuning stage 416, hyperparameter optimization 426, as described above, may be implemented to yield candidate pipelines 418 from which selected pipelines 440 are obtained. Example pipelines may include sequences of code with various functional segments, e.g., BERT-pre-Processing, BERT-Embedding, Drop out, MLP Classification, CNN-pre-Processing, CNN-Embedding, LSTM, and MLP Classification.

Each of the stages 412, 414, 416, 418, and 440 may provide input for actions occurring within them to the analysis report generator 452 (320) and explanation assembler 454 which may be utilized to put multiple pipelines together. This information may be used to prepare an analysis or a report 460 that is, e.g., a physical report that may be printed on paper or other tangible media, or a digital report that is reproduced on a user interface 450. An evaluation process 442 may receive holdout data 444 and the data from the selected pipelines 440 to produce display data for the user interface 450. The holdout data 444 is a subset of the entire training data. For example, 80% of the training data may be used to train the model to get an accuracy score, and then, the 20% holdout data 444 may be used to get a score for that same model. The holdout data score is more accurate because the model has not been exposed to it during the training. The user interface 450 may provide feedback 462 in the form of data input and user preferences that are obtained from the user.

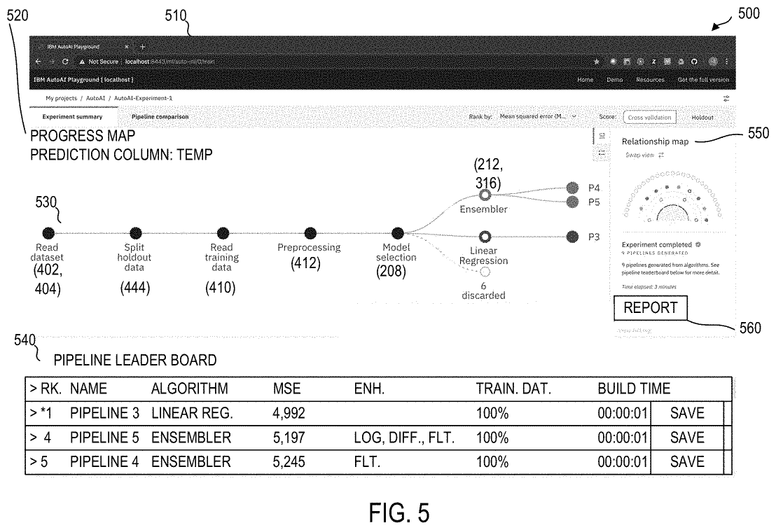

FIG. 5 is an example of a display screen 500 on a user interface 450 device, such as a monitor that may advantageously be used to present information about the system to the user in a meaningful way. The display screen 500 may comprise, in some embodiments, an application window 510 that contains a display of the analysis, such as the report 460, or formatted display of the evaluation process 442. In one example the application shows a progress map 520 with a prediction column TEMP. The progress map 520 shows the various stages and progress of the experiment pictorially in the form of a timeline 530, including reading the dataset (402, 404), splitting the holdout data (444), reading the training data (410), preprocessing (412), and model selection (208). In the model selection, it can be seen that a split is made for different pipelines: Pipeline 3 (P3), Pipeline 4 (P4), and Pipeline 5 (P5). A further Pipeline 6 has been discarded. P3 is identified with a linear regression algorithm, and P4, P5 are associated with the ensembler algorithm.

A pipeline leader board 540 is shown in which, in some embodiments, the rank, pipeline name, optimized metrics (e.g., mean squared error (MSE), F1, etc.), enhancements (e.g., log, difference, flatten), training data used, and build time are shown for each of the pipelines. A save button may be provided for each of the pipelines that, e.g., serves as a model picker or a model file for future usage. A relationship map 550 may be provided that shows an overview of the pipelines and their relationships relative to one another. A report user interface element such as a report button 560 may be provided to initiate a report download and/or automatic generation of a viewable report when activated.

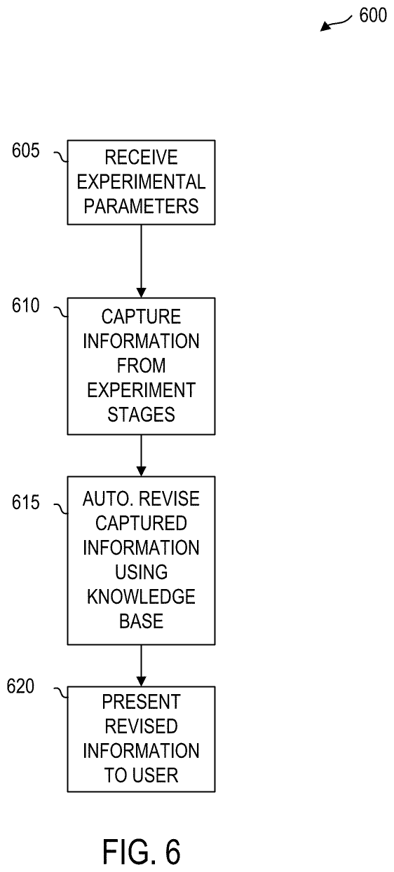

FIG. 6 is a flowchart of a process 600, according to some embodiments. In operation 605, experimental parameters are received by the AAT 320. The AAT 320 may then, in operation 610, capture information from the plurality of experiment stages 412, 414, 416. In operation 615, the AAT 320 may revise the captured information using information from the knowledge base 312. The revised information may subsequently be presented to the user via, e.g., a user display or a report 342 that presents experiment results, choices, rationales, and model results.

### Technical Application

The one or more embodiments disclosed herein accordingly provide an improvement to computer technology. For example, an improvement to a reporting mechanism in a machine learning process allows for more, efficient, and effective analysis of machine learning stages and components.

### Computer Readable Media

The present invention may be a system, a method, and/or a computer readable media at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for, by a processor, using an automated analytic tool (AAT) for analyzing a machine learning system (MLS), comprising:
receiving experiment parameters associated with an experiment performed on the MLS;
capturing information from a plurality of stages of the experiment, wherein the information comprises information regarding MLS results and choices made during the experiment;
automatically revising the captured information into revised information utilizing a knowledge base comprising information from prior experiments; and
presenting the revised information to a user.

2. The method of claim 1, wherein the plurality of stages of the experiment include a data refinement stage, a feature transform stage, a model selection stage, a model tuning stage, and a pipeline selection stage.

3. The method of claim 1, further comprising providing an explanation of rationale behind the choices made at each of the plurality of stages of the experiment.

4. The method of claim 1, further comprising:
receiving a request, based on a user interaction with a display element on a user interface, to view or download the revised information of the experiment and present different possibilities of the experiment.

5. The method of claim 1, further comprising:
receiving, via a question and answer mechanism, a user question associated with the experiment; and
presenting an answer that is responsive to the user question.

6. The method of claim 1, further comprising:
receiving edit information from the user on the revised information;
integrating the edit information into the knowledge base; and
using the edit information for a future experiment.

7. The method of claim 6, wherein the knowledge base is structured as a memory network.

8. The method of claim 7, wherein the memory network comprises data from a plurality of stages of past experiments.

9. The method of claim 1, wherein the presenting of the revised information to the user comprises:
presenting, for display on a user device:
a progress map that pictorially illustrates progress of the experiment;
a pipeline leader board that displays pipeline rankings, name, and algorithm; and
a report user interface element that, when activated, initiates a report download and/or automatic generation of a viewable report.

10. An automated analytic tool (AAT) apparatus for analyzing a machine learning system (MLS), comprising processor configured to:
receive experiment parameters associated with an experiment performed on the MLS;
capture information from a plurality of stages of the experiment, wherein the information comprises information regarding MLS results and choices made during the experiment;
automatically revise the captured information into revised information utilizing a knowledge base comprising information from prior experiments; and
present the revised information to a user.

11. The apparatus of claim 10, wherein the plurality of stages of the experiment include a data refinement stage, a feature transform stage, a model selection stage, a model tuning stage, and a pipeline selection stage.

12. The apparatus of claim 10, wherein the processor is further configured to provide an explanation of rationale behind the choices made at each of the plurality of stages of the experiment.

13. The apparatus of claim 10, wherein the processor is further configured to:
receive a request, based on a user interaction with a display element on a user interface, to view or download the revised information of the experiment and present different possibilities of the experiment.

14. The apparatus of claim 10, wherein the processor is further configured to:
receive, via a question and answer mechanism, a user question associated with the experiment; and
present an answer that is responsive to the user question.

15. The apparatus of claim 10, wherein the processor is further configured to:
receive edit information from the user on the revised information;
integrate the edit information into the knowledge base; and
use the edit information for a future experiment.

16. The apparatus of claim 15, wherein the knowledge base is structured as a memory network.

17. The apparatus of claim 16, wherein the memory network comprises data from a plurality of stages of past experiments.

18. The apparatus of claim 10, wherein the processor is further configured to, in the presentation of the revised information to the user:
present, for display on a user device:
a progress map that pictorially illustrates progress of the experiment;
a pipeline leader board that displays pipeline rankings, name, and algorithm; and
a report user interface element that, when activated, initiates a report download and/or automatic generation of a viewable report.

19. A computer program product for analyzing a machine learning system (MLS), the computer program product comprising a computer readable storage medium having computer-readable program code embodied therewith to, when executed on a processor:
receive experiment parameters associated with an experiment performed on the MLS;
capture information from a plurality of stages of the experiment, wherein the information comprises information regarding MLS results and choices made during the experiment;
automatically revise the captured information into revised information utilizing a knowledge base comprising information from prior experiments; and
present the revised information to a user.

20. The computer program product of claim 19, wherein the instructions further cause the processor to:
present, for display on a user device:
a progress map that pictorially illustrates progress of the experiment;
a pipeline leader board that displays pipeline rankings, name, and algorithm; and
a report user interface element that, when activated, initiates a report download and/or automatic generation of a viewable report.
